(19) United States
(12) Patent Application Publication
(10) Pub. No.: US 2001/0007098 A1
(43) Pub. Date: Jul. 5, 2001

(54) Gift certificate award and exchange program and method

(76) Inventors: Susan E. Hinrichs, San Francisco, CA (US); Diogo P. Rau, San Francisco, CA (US); Hongyu Ximen, Cupertino, CA (US); Joseph Bach, Morgan Hill, CA (US)

Correspondence Address: JOSEPH BACH, 17460 LAKEVIEW DRIVE, MORGAN HILL, CA, 95037, US

(21) Appl. No.: 09/777,527

(22) Filed: Feb. 6, 2001

Related U.S. Application Data
(63) Continuation-in-part of application No. 09/475,744, filed on Dec. 30, 1999.
(60) Provisional application No. 60/180,615, filed on Feb. 7, 2000.
(60) Provisional application No. 60/181,235, filed on Feb. 9, 2000.

(51) Int. Cl. G06F 17/60

(52) U.S. Cl. 705/14; 705/26; 705/27

(57) ABSTRACT

A method and an apparatus for providing employee gift certificates award and exchange are described. The method and apparatus enable the award of a certificate either automatically upon an occurrence of a designated event, such as a birthday, or upon request, such as by a manager. The method and system also enable the employee to exchange the certificate for goods from various merchants over the internet using a single point shopping cart. The shopping cart accesses the various merchants' sites, searches for specific purchase-related fields, creates a database of those fields, and creates a hyperlink to that merchant's site. When the employee wishes to access the merchant's site, the shopping cart acts as a proxy for the user, but also monitors the communication for specific requests. If a specific request, such as add to cart, has been identified, the shopping cart doesn't relay this request to the merchant's shopping cart, but rather fetches relevant shopping data from the fields database and composes a purchase order which is sent to the merchant's site. The amount of the purchase is applied against the certificate.

This application is a continuation of Provisional Patent Application 60/180,615 filed Feb. 7, 2000 and Provisional Patent Application 60/181,235 filed Feb. 9, 2000; and is further a continuation in part of patent application 09/475,744, filed Dec. 30, 1999.

### BACKGROUND OF THE INVENTION

1. Field of the Invention

The present invention relates to recognition, award, and gift programs. More particularly, the invention relates to gift certificate award and redemption programs. The invention is particularly beneficial for programs wherein an employer awards employees using gift certificates, although it may be used in other arrangements.

2. Description of Related Art

A practice has been evolved in many workplaces wherein employees are recognized upon achieving certain milestones of service. For example, employees may be awarded on the two, five, ten, etc. years of employment with the company. Upon the anniversary of these milestones, it is customary to recognize and award the employee for the good service, so as to encourage loyalty. Other forms of award are generally referred to as “spot” awards, e.g., when a manager recognizes a specific employee or team, and general awards, e.g., when all the employees are recognized and rewarded. In small to medium companies, a small ceremony may take place, during which the manager of the employee may award the employee a specific premium chosen for the occasion. Additionally, the employee may be provided with gift certificates redeemable at a specific merchant.

However, for large companies, keeping track of these events and awards imposes excessive overhead, and having a recognition ceremony for each such occasion becomes unmanageable. If a company employs several hundreds or thousands of employees, it may need to conduct such a ceremony almost every day. Consequently, an industry has evolved to serve the needs of companies to recognize and award their employees. Specialty premium companies track employees' anniversary dates. When an employee has achieved a service milestone, the premium company sends a congratulating letter to the employee. In some cases, the letter is accompanied by a catalog of premium awards, and the employee is requested to select a premium from the catalog and send the selection to the premium company. A fulfilment house then sends the chosen premium to the employee.

The use of a premium company according to the prior art has several drawbacks. First, in order to track the anniversary dates, the premium company maintains a record of the employees. This may compromise the confidentiality of the employees' records. Second, having the recognition letter sent by a premium company rather than the employer is very impersonal. It is much more preferable that the letter would at least have the appearance of being sent by the employer. Third, the present system is not dynamic. That is, once a catalog is created, it is very difficult to substitute new premiums. Fourth, the process of receiving the recognition letter in the mail, returning the postcard identifying the selection, and receiving the premium by return mail is somewhat protracted, so that there is no tight connection between the recognition and the award. Similarly, if a prior art gift certificate is awarded, such as an American Express™ certificate, there is no process for the company to track and monitor these certificates.

Another relevant art is central shopping web sites on the internet, and is generally referred to as a “single point shopping cart.” Specifically, many merchants have set up web site enabling shopping of various items. However, all the items on such web sites are limited to items sold by that specific merchant. For example, if the merchant sells consumer electronic goods, one may be able to purchase a compact disk player, but may be unable to shop for compact disks. Therefore, a single shopping cart has evolved to provide shoppers with a single web site for shopping at multiple merchants, but paying at a single location. An example of a single shopping cart is depicted in FIG. 7.

In FIG. 7, a user 700 logs onto the shopping cart server 710. At the shopping cart site 710 the user 700 may select to shop at one of the specified number of merchants, exemplified by icons 721 and 731. Once the user clicked on one of the icons, 721, 731, the shopping cart server acts as a proxy for the user, in a manner well known in the art. For example, once the user clicks on icon 721, all requests from the user 700 to the site of merchant 720 are sent first to the shopping cart 710, and are then relayed to the merchant 720. Similarly, all responses from the merchant 720 are sent to the shopping cart 710, and from there are relayed to the user 700. However, in order to implement the single pont-of-contact feature of the shopping cart, when the user 700 sends a purchase request, this request is intercepted by the shopping cart 710 and is not relayed to the merchant 720. Rather, the shopping cart 710 collects all the purchase requests from the user 700, and after the user completes his shopping, the shopping cart places the appropriate orders with the merchant in accordance with a pre-arranged procedure between the shopping cart and the merchants. As can be understood, in this manner the user makes a single payment to the shopping cart company for all the items purchased, and the shopping cart company makes appropriate payment distribution to the various merchants according to the items purchased.

While the single shopping cart of the prior art enables a single point-of-contact for shoppers, its main disadvantage is that it requires a pre-arrangement with each merchant made available on the shopping cart. This requires intense inter-company coordination efforts which protract the time it take to integrate a new merchant. Consequently, the number of merchants made available is limited. Notably, since the listing of merchants needs to be pre-negotiated with each merchant, it is rare that a shopping cart would list two competitors on its site. Therefore, the ability of a user to compare competitors is drastically reduced.

Accordingly, there is a need in the art for a more efficient and versatile gift award and redemption system.

### SUMMARY OF THE INVENTION

The present invention provides a versatile and efficient system that monitors employees anniversaries. An e-mail system is used to send the award letter, and the internet is used to allow access to a premium catalog and choice of a premium award. Additionally, or alternatively, the internet is used to enable shopping at various merchants' web sites.

According to one embodiment, the recognition e-mail is generated in a manner to appear as if it was generated and sent by the employee's manager. Additionally, the recognition e-mail includes a hyperlink to a web site that includes a catalog of the premiums available to the employee. While the premium catalog is structure with multiple levels of awards, the hyperlink allows the user to access only the catalog pages appropriate to the anniversary level the employee has achieved.

According to another embodiment, the award or gift email includes a hyperlink to a shopping cart, and an award account is established at the shopping cart. The shopping cart allows access to various merchants shopping sites, while the shopping cart acts as a proxy for communication between the user and the merchants' sites. When the user places a purchase order, the order is intercepted by the shopping cart and stored. When the user completes shopping, all the purchase order are processed against the award account of the user.

According to a specific embodiment, a service provider's server includes a customer's employees database and monitors this database for anniversaries. When an anniversary has been recognized, the server sends a recognition e-mail to the employee. The e-mail includes a hyperlink to a premium catalog on the provider's server. Thus, when the employee clicks on the hyperlink, the employee can access a premium catalog and make a selection of the premium the employee wishes to receive. Since the catalog is stored electronically, it may easily be modified at any time and tailored to specific occasions, thus providing versatility. Also, many premiums can be made available instantly by downloading over the internet, thus making a tight connection between the recognition and the award. For example, premiums can be in the form of downloadable software, audio, or video file, printable concert tickets, store vouchers, gift certificates, etc. Moreover, the awards can be provided from several vendors via links to their respective web sites.

According to another embodiment, the employer's server monitors anniversaries and sends recognition e-mails to the employees, including the hyperlink to a premium company's catalog. At the same time, the employer's server also sends a notification to the premium company's server indicating that recognition e-mails have been sent to identified employees, so that they may gain access to the premium company's catalog. In actual implementation, the premium catalog may reside in the employer's intranet or on the premium company's server. According to this embodiment, full confidentiality of the employees' records is maintained. Also, since the premium selection is done via the internet, the premium system is versatile and flexible.

According to yet another implementation, a premium company's server monitors its database for anniversaries, birthdays etc. When the server gets a hit, it sends a prompt to an engine in the employer's server. When the prompt is received, the engine formulates and sends a congratulation e-mail to the identified employee. The e-mail contains a hyperlink to a premium catalog that the employee can choose from. In this manner, the e-mail is sent from the employer's sever and appears more personal. Also, in order to maintain confidentiality, minimum information can be maintained on the premium company's database.

For example, the premium company's database may include only the employee number, day and month of birthday, and the date the employee joined the company. When the premium company sends a prompt to the employer's server, the prompt may include only the employee number and an event code (e.g., anniversary, birthday, etc.). The employer's server uses the employee code to fetch the pertinent information (e.g. employee name, manager's name, etc.) from the company's HR database, and uses that information to formulate the recognition e-mail In this way, only minimal amount of information resides in the premium company's database. Also, since the manager's name can be fetched from the HR database, the e-mail can be structured as if it is sent by the employee's manager.

The inventive system can also be used for random awards, e.g., completion of project, job well done, etc. For example, several management level employees can be provided with an access to the system, with a designated annual budget. When a manager wishes to reward an employee, he may access the system, enter the employee's name, select the appropriate occasion, and select the award price level. Then an e-mail is generated and sent to the employee with the congratulation message. The e-mail also includes a hyperlink to an award page for the appropriate price level selected by the manager.

According to yet another embodiment, the employer's server monitors anniversaries and sends recognition e-mails to the employees, including the hyperlink to a premium company's catalog. At the same time, the employer's server also sends a notification to the premium company's server indicating that recognition e-mails have been sent to identified employees, so that they may gain access to the premium company's catalog. The email to the premium company contains sufficient information to enable the premium company to compile a database. In about a year, the premium company would have collected sufficient data to enable it to remove the burden of tracking the anniversaries from the employer. Once this point is achieved, the entire program can be moved to the premium company and totally removing the burden from the employer.

According to a further embodiment, which can be implemented in conjunction with any of the above noted embodiments, an electronic gift certificate is issued to the employee and sent to the employee via email. Additionally, a gift account is established for the employee at a shopping cart site. When the employee logs onto the shopping cart, the employee may shop at any of a multitude of merchants' sites, while the shopping cart acts as a proxy. When the employee places a purchase order, the shopping cart intercepts the order and stores it. When the employee completes shopping, the shopping cart places orders with the appropriate merchants and charges the purchase amounts against the gift account.

According to another embodiment, a “screen scrapping” engine is used to construct and operate the shopping cart without having to pre-negotiate terms with the various merchants. Specifically, the engine access various merchants' sites and checks the pages to find and record all the fields available on the site. It then enables access to that merchant from the shopping cart site. When a user accesses the merchant's site, the shopping cart acts as a proxy and the engine monitors all communication between the user and merchants for tracking of specific fields. When it recognizes a specific input in a specific field, it performs a corresponding operation. For example, upon recognizing a purchase field, it intercepts the order and adds it to the shopping cart of a service provider, rather than shopping cart of the merchant. It then monitors for a price, quantity, etc., fields to complete the placement of the order. Consequently, there's no need to pre-negotiate with the merchant and competitor merchants can be made available on the shopping cart to enable comparisons.

According to yet another embodiment, the screen scrapping engine is used to reduce traffic at the shopping cart site. For example, when the engine recognizes a request for a page from a merchant, the shopping cart acts as a proxy and transfers the request to the merchant, and the reply page to the user. However, when the reply page contains additional requests, such as images, for example, the engine recognizes those requests and allows those requests to go directly between the user and the merchant, thereby bypassing the shopping cart server and reducing traffic through the shopping cart server.

It should be appreciated that while the description is provided in terms of employer-employee arrangement, the invention can be used with any type of organization-member arrangement, such as automobile clubs, credit unions, etc. Additionally, it may be implemented for awarding gift certificates between any two individuals, such as parents and children, husband and wife, etc.

### BRIEF DESCRIPTION OF THE DRAWINGS

Various embodiments of the present invention are described below with reference to the following Figures. The embodiments and Figures are provided to exemplify the features and aspects of the present invention, and should not be construed as limiting the invention as defined by the appended claims.

FIG. 1 is a block diagram exemplifying an embodiment of the present invention.

FIG. 2 is a block diagram exemplifying another embodiment of the present invention.

FIG. 3 is a flow chart exemplifying a method of operating the embodiment of FIG. 2.

FIGS. 4a and 4b exemplify inventive features operable independently, or in conjunction with any of the exemplified embodiments.

FIG. 5 is a block diagram exemplifying yet another embodiment of the present invention.

FIG. 6 exemplifies an award catalog according to the present invention.

FIG. 7 is a block diagram of a prior art single point shopping cart system.

FIG. 8 exemplifies an embodiment of a shopping cart according to the present invention.

FIG. 9 is a flow chart of another feature of the invention which may be implemented in conjunction with the various embodiments of the invention.

FIG. 10 is a block diagram of yet another embodiment of the present invention.

FIG. 11 exemplifies an embodiment incorporating various features of the present invention.

### DETAILED DESCRIPTION OF VARIOUS EMBODIMENTS

A better understanding of the various embodiments of the present invention may be facilitated by considering two families of embodiments. One family of embodiments of the present invention is applicable to any organization-member situation, such as, for example, automobile club, credit union, etc. That is, such family of embodiments is applicable to any situation where a relationship exists between a central organization and individuals, wherein the central organization wishes to provide gifts to the individuals from time to time. Another family of embodiments of the present invention is applicable to any relationship wherein one person wishes to provide a gift certificate for another individual. Thus, for example, a parent may wish to provide a gift for a child, or a husband wishes to provide a gift for his wife. As can be understood by those skilled in the art, the demarcation of the families of embodiments is mainly for purposes of understanding the invention, but in actuality either embodiment may be used for both types of relationships.

For convenience, much of the following description is provided with reference to employer-employee relationship. However, the use of this exemplary relationship should not be, in any way, construed as limiting the applicability of the invention to other situations, such as those just mentioned.

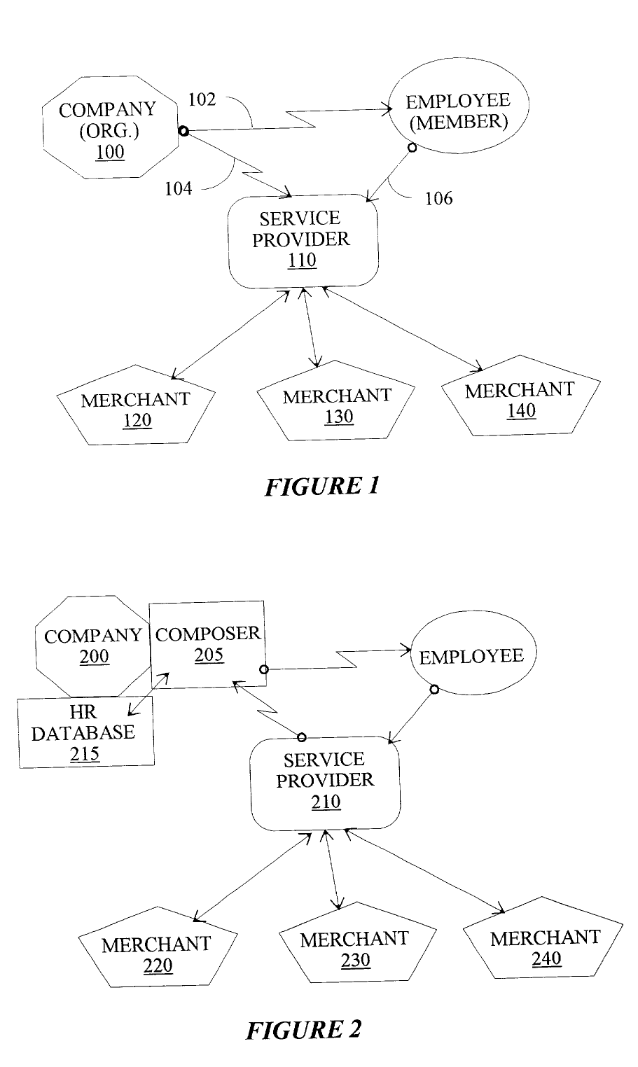

FIG. 1 is a block diagram exemplifying an embodiment of the present invention. Element 100 is an employer (or organization) server, while element 110 is a service provider's server. It should be understood that in the description the terms “service provider” and “shopping cart” are used interchangeably, since the service provider may be implemented as a shopping cart. Elements 120, 130, and 140 exemplify optional merchants' servers. As exemplified in this embodiment, the server 100 monitors the employees (or customers, members, etc.) database for events. When an event appears, the server 100 sends an appropriate e-mail (102) to the employee (or customer, member, etc.). The e-mail (102) includes a hyperlink to a web site residing on sever 110. The server also sends an e-mail (104) with a code to the server 110, optionally identifying the employee and the event. In other implementation, the code is merely a password that is sent to the employee and the service provider, and does not identify the employee or event.

When the employee receives the e-mail, the employee may click on the hyperlink (106) and go to the designated page on server 110. Notably, according to one feature of the invention, the company may wish to have different levels of awards, depending on the occasion. For example, awards priced at up to $50, $200, and $500, for the two, five and ten years anniversaries, respectively. To accomplish that, the site on server 110 is divided into award levels, and the employee is given access only to the awards pages matching the award level achieved by the employee. This can be done, for example, by including an award level in the e-mail (104) sent by server 100, matching an award level to the code, or limiting the access afforded by the hyperlink included in e-mail (102).

One method of performing the above in a secured manner is to include validation information or code in the hyperlink's URL. For example, the URL may include the premium company's web site address, the employee's email address for authentication, and a code identifying the award type and level. To illustrate, where P1 stands for the employee's email and P2 stands for the award code, the URL may be:

www.BeyondWork.com/P1=employeename@company.com/P2=A100; where A100 is a code for anniversary and award limit of $100.

If the P1 and P2 information is included only in the hyperlink sent to the employee, then when the employee logs onto the premium company's web site, the server checks the PI information to verify that the email address matches an address from a member company, and checks the P2 information to determine on which areas of the site the employee may access and which type of awards he may select. However, preferably, the P1 and P2 information is also sent to the premium company, so that when the employee clicks of the hyperlink and enters the premium company's server, the server compares the P1 and P2 data for verification. Of course, once the employee logs onto the premium company's server, cookies can be used in a known manner to store appropriate passwords and other codes on the employee's computer for future logon verification.

Alternatively, the emails 102 and 104 contain a code. The employee may then access the server 110 either by clicking on the hyperlink or directly via a web browser. The user then is requested to enter the code as a password. If the code matches, the employee is allowed access to shopping. Of course, in the background, when the server 110 receives the email 104 with the code, it establishes an account for that code with a specific designated allowance spending amount.

As noted previously, some of the awards may be vouchers, coupons, gift certificates etc. Therefore, according to the embodiment of FIG. 1, the site pages further include links to various participating merchants 120, 130, and 140. So, for example, products marketed by a certain merchant can be displayed on the site of server 110, and a hyperlink would be provided for ordering the chosen product directly from the merchant's server. Specifically, when a connection is established to a merchant's server via the link, appropriate voucher or coupon can be transferred to the merchant's server to allow the employee to use the voucher or coupon. Again, as in the previous example, the URL of the hyperlink on the premium company's web site may include information identifying the user as an employee receiving premium award. This will again ensure that the employee may order only the specific award shown on the premium company's catalog.

Alternatively, the site on server 110 merely provides icons with hyperlinks to the various merchants' web pages. When the employee clicks on such an icon, the server 110 acts as a proxy for communication between the employee and the merchant. For example, when the employee clicks on the icon, a request for a page from the merchant's server is originated by the server 110, having server 110 address as a requesting address. The requested page is then sent to the server 110. The server 110 then relays the page to the employee's computer. However, when the employee places a purchase order, the server 110 intercepts the order and does not relay the order to the merchant, although from the employee's perspective it appears as though the order was placed with the merchant. When the employee completes the shopping session, the server 110 deducts the total amount of all the items from the account, and places the orders for the various items with the corresponding merchants. A more details explanation of this entire process is provided further below.

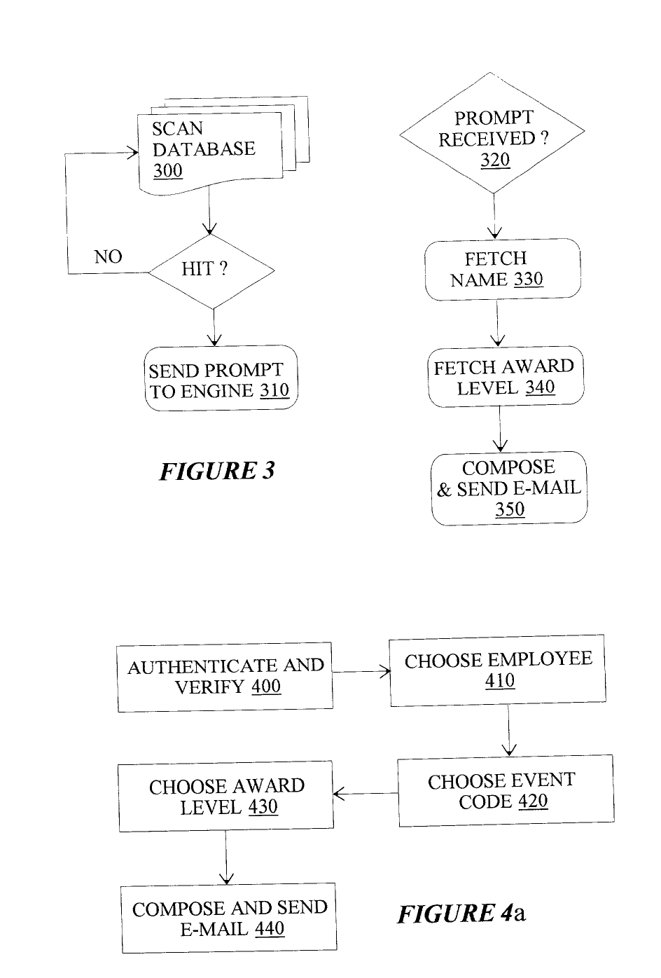

Another embodiment is exemplified in FIG. 2. According to this embodiment, a composer 205 and an HR database 215 reside on an employer's server 200. Minimal, but sufficient, data from the HR database is replicated on the service provider's server 210. Such data may be, for example, employee number, day and month of birthday, and date joined the employer company. The server 210 monitors the replicated data for events (Step 300, FIG. 3). When an event is encountered, server 210 sends a prompt to composer 205 (Step 310). The prompt may include, for example, employee number and an event code.

When composer 205 receives a prompt (Step 320), it fetches the appropriate data from the HR database 215, using the code included in the prompt (Step 330). For example, using the employee number, the employee's name and manager's name can be fetched from the HR database. Of course, since the employee's birthday and date joined the company is stored in the HR database 215, the prompt may include only the employee number and the composer 205 can determine the event by matching the date on which the prompt was sent to the dates in the employee's file in the database.

Using either the code in the prompt or the date in the employee's file, the composer determines the award level. Then, the composer composes and sends an e-mail which congratulates the employee and includes a code and/or a hyperlink to a web page corresponding to the award level (Step 350). Since the e-mail was generated by the employer's server, it appears more personal to the employee. That is, the e-mail is generated and sent from within the employer's intranet. Moreover, in composing the e-mail the composer may insert the employee's manager in the “sent from” line, thus enhancing the personal appearance of the message. When the employee receives the e-mail, the employee may click on the hyperlink and examine awards presented in an award catalog, or brows merchants' pages for other merchandise. The catalog may reside on the employer's server 200 or the service provider's server 210. As in the embodiment of FIG. 1, hyperlinks can be provided on service provider's web site 210 to servers of merchants 220, 230, and 240 for award or certificate redemption.

It should be noted that, in the exemplified embodiments, the service provide's server is depicted as separate from the employer's server. However, the functions performed by the service provider's server can all be performed by the employer's server. That is, when the employer is concerned with security and prefers that employees will not go out of the employer's intranet, the service provider may upload all of the programs that generally perform the functions described above onto the employer's server. Thus, the entire recognition and award program can be run within the employer's intranet. Moreover, using secure servers, connections can be made to the merchants for on-line redemption of awards.

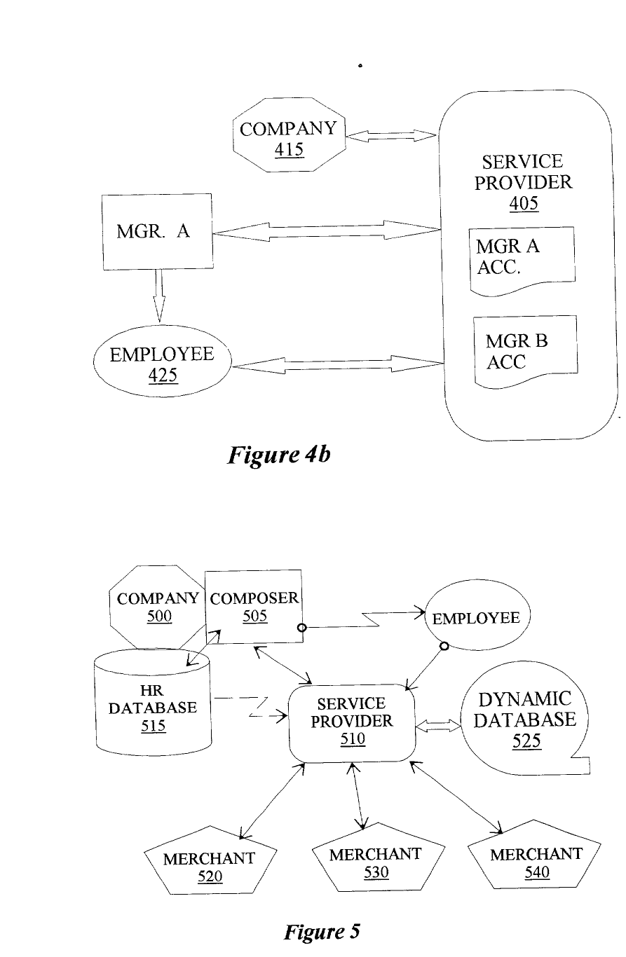

A feature of the invention that may be implemented independently or in conjunction with any of the embodiments described herein is exemplified in FIGS. 4a and 4b. This feature enables authorized managers to award employees at any time, such as on special occasions, e.g., record sales, completion of a project, etc. According to the example of FIG. 4a, when a manager wishes to award an employee, the manager accesses the award program, which authenticates the manager and verifies that the manager indeed has the authorization to access the program (Step 400). If so, the manager can then choose an employee, event code, and award level (Steps 410, 420, 430), simultaneously or in any particular order. Using the employee's name, event code, and award level, the server composes and sends an e-mail to the employee with the appropriate congratulation note, password, and/or a hyperlink to the appropriate service provider web site.

FIG. 4b depicts another embodiment, wherein the company 415 enables its managers to give employees gifts at the managers' discretion. In this example, company 415 sets up with service provider 405 various managers accounts, Mgr. A Acc., Mgr B Acc., etc., each having a specific amount of credit. The manager may access its designated account and may: award a gift to an employee; transfer credit to another manager's account; request additional funds; add additional funds using a credit card, etc. To award a gift to an employee 425, the manager access the account and sends an award email to the employee 425. In this example, the email includes a code, which is also stored on the service provider server 405 together with an award amount. When the employee access the server provider's site and enters the code, the server verifies the code and associates the award amount with the employee by either creating a new account for the employee, or relegating a portion of the manager's account according to the award amount. The employee 425 may then select a gift, either from a catalog or browsing merchants' sites, and each purchase is debited against the award amount.

An embodiment that is somewhat of a hybrid of the embodiments of FIGS. 1 and 2 is exemplified in FIG. 5. In the embodiment of FIG. 5, a dynamic database 525 is added to the service provider 510. When a service agreement is signed with a company, no information from the HR database 515 is transferred to the service provider 510. Rather, the information is transferred individually with respect to each employee and each event, as events occur. That is, whenever an event occurs and an award is given to an employee, the information is transferred to the service provider and stored in the dynamic database 525. In this manner, the dynamic database 525 is built to cover all employees and annual events.

More specifically, the company's HR database 515 is monitored for events. When a hit is encountered, the composer 505 prepares a congratulation message and sends it to the employee. Additionally, a message is sent to the service provider 510, providing data about the employee and the event/award combination. The message can include, for example, employee name and number, employee's manager, event (e.g., birthday, anniversary, etc.), and award level. This data can then be used to reduce the company's overhead in future years. That is, the data is added to the dynamic database 525 from each received email. As more data is collected in the dynamic database 525, the premium company will be able to take more of the load from the employer and manage more of the award program for the employer. Also, preferably a regular update is sent from the HR database 515 to the service provider 510, as demonstrated by the broken arrow.

If indeed management of the award program is transferred to the service provider 510, then at that time the system can revert to the embodiment of FIG. 2. That is, the service provider 510 would monitor the dynamic database 525 for events, and send event notifications to the composer 505. Of course, since the dynamic database may include sufficient information about the employee, the event, and the award level, the composer 505 may not need to access HR database 515. Alternatively, at the time management of the program is transferred to the service provider, the service provider 510 also assumes the responsibilities of the composer 505 and prepares the award message. The service provider may send the award message directly to the employee, or send it to the employee's manager so that the employee's manager may forward it to the employee.

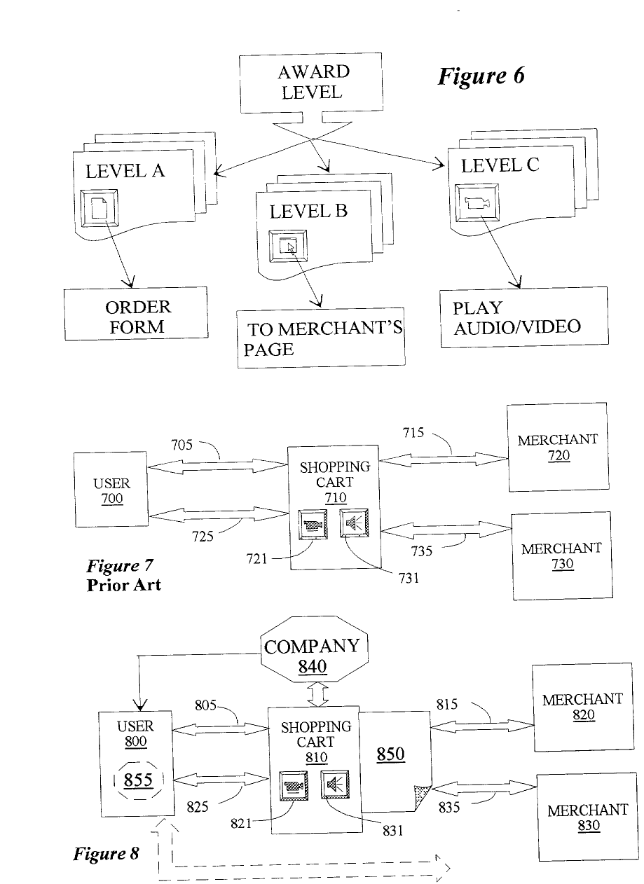

FIG. 6 exemplifies an award catalog that can be used with any of the above described embodiments of the invention. Specifically, when an employee clicks on the hyperlink provided in the award notice, the Http: request will be sent to the appropriate portion of the catalog, depending on the award level. A specific catalog is provided for each award level, indicated in FIG. 6 as levels A, B and C. Each catalog may include various awards that may be ordered from the service provider directly, or from a participating merchant. For example, the item on the first page of the Level A catalog can be ordered directly from the service provider. This is exemplified by the link to the order form. Of course, if the award is downloadable, such as an electronic file or a printable gift certificate, the link can be made to the downloadable file.

On the other hand, the award may be ordered from a participating merchant. This is exemplified by the link in the first page of the Level B catalog. That link is to a corresponding page on the participating merchant's web site. When the employee clicks on this link, the service provider's server acts as a proxy for all future communication. However, when the user clicks on a “buy” or “purchase” icon, the service provider's server intercepts this Http: request and doesn't send it to the merchant's site. Instead, the service provider's server stores all “purchase” requests, deduct the amount of the purchase from the award amount, and display to the employee the amount still available in the account. Once the employee completes the shopping session, the service provider places all the shopping requests with the corresponding merchants.

Additionally, more information about the awards can be provided in the form of an audiovisual file. This is exemplified in the link provided in the first page of the Level C catalog. It should be appreciated that each award in each of the catalogs may have any combination of the links and, indeed, may have all the links. That is, any particular award may have a link to an audiovisual file for additional information, and may have a link to an order form from the service provider or from a participating merchant and the employee may choose from whom to order the award.

A detailed explanation of an embodiment of a shopping cart according to the present invention will now be described with reference to FIG. 8. Specifically, unlike the prior art shopping cart arrangements wherein the shopping cart company has to negotiate ordering and pricing arrangement with the various merchants beforehand, the shopping cart exemplified in FIG. 8 requires no arrangement with the merchants and can make any merchant site available for shoppers through the shopping cart. The operation of the shopping cart of FIG. 8 can be understood from the following example.

Shopping cart 810 includes a screen scraper engine 850. To make merchant site 820 available on shopping cart 810, site 820 is accessed and the screen scraper examines the various fields on the various pages in the site 820. For example, the screen scraper may identify a product description or product code and its associated data, such as price, shipping weight, shipping origin, etc. The screen scraper also looks for data entry fields, such as quantity, shipping address, etc. Then, for each such web site a corresponding fields database is created, and an icon for accessing the web site is added to the shopping page of the shopping cart site. Notably, this entire process is done electronically over the internet and merchant 820 need not be aware of the process or that a link to the site 820 was added to shopping cart 810. This process is repeated for any selected merchant web site to make them available on shopping cart 810, and may be repeated periodically for updates.

When a user 800 accesses shopping cart 810, the user may select to shop at any merchant available on shopping cart 810. So, for example, when the user selects icon 821, shopping cart 810 sends an Http: request to merchant 820. As can be understood, since the Http: request was originated by the shopping cart 810, merchant 820 sends the requested html page to shopping cart 810. Shopping cart 810 then sends that html page to user 800. In this manner, from the user 800 perspective, the requested page has arrived directly from merchant 820. Furthermore, when user 800 clicks any icons on the requested html page, the icon request is sent to shopping cart 810, since from user 800 computer, shopping cart 810 was the originator of html page. When the shopping cart 810 receives such an icon generated Http: request, it forwards it to the merchant 820. That is, shopping cart 810 acts as a proxy and the user 800 has the experience as if he shops directly at the merchant 820 web site.

The screen scraper 850 checks all communication received from user 800 and merchant 820. When the screen scraper 850 identifies a “buy” request received from user 800, it prevents shopping cart 810 from transmitting that request to merchant 820. Rather, the shopping cart fetches the relevant fields, such as quantity, shipping information etc., from the fields database and sends it to be displayed for the user 800 for approval or to inform the user of the total price, shipping time, etc. Advantageously, unlike the prior art wherein the user has to advance several levels before the entire order is completed and displayed, in this embodiment, since from screen scrapper 850 it is known where all the fields reside on the merchant's server, these fields are entered by shopping cart 810 and the relevant data is fetched and the entire transaction is completed and displayed for the user 800.

For example, it is well known in the prior art that the shipping charge is often not displayed until the last stage of the order has been reached. Moreover, applicable taxes may not be displayed at all and only appear in the charge statement. However, sometimes the amount of the taxes and shipping charges is significant and may be relevant during the comparison shopping stage by user 800. However, in the prior art, in order to consider the shipping charges the user must progress through all the ordering levels on each merchant's site. This is cumbersome and time consuming. Therefore, according to the embodiment exemplified in FIG. 8, when a field such as “product information,” “compare,” “add to cart,” etc., is recognized from the user 800, all the fields, e.g., price, shipping charges, etc., on the merchants site are accessed and displayed to the user immediately.

Additionally, the shopping cart fetches the ordering fields for merchant 820 from the fields database and generates an order for the item by inserting in the fields the appropriate information, such as quantity, shipping address, shipping method, etc.

The shopping cart 810 is particularly advantageous for use in conjunction with the award program described above, which can be appreciated from the following example. User 800 receives an award email, from employer 840 for example, which includes a gift certificate and an award code. User 800 then logs onto shopping cart 810 and enters the award code. Shopping cart then verifies the code and, if valid, establishes or associates an award account for user 800. The user may then click on any of the merchants' icons displayed at shopping cart 810 and shop at any of the merchants' sites. The shopping would be conducted with the shopping cart acting as a proxy, as explained above. When the shopping cart recognizes a “buy” order from the user 800, the shopping cart sends a request to user 800 to input shipping address, shipping method etc. The shopping cart then totals the amount of purchase and deducts it from the award credit available to user 800, and displays it to the user. Additionally, the shopping cart fetches from the fields database the appropriate fields for order placing with the selected merchant. Shopping cart 810 inserts the shipping address and quantity obtained from user 800, but in the charge field it doesn't insert charging information of user 800, but rather that of the entity issuing the gift certificate, or of the shopping cart company itself In this manner, the gift certificate can be used at any merchant or combination of merchants and is not limited to a single issuing merchant.

Moreover, since the shopping cart monitors the award accounts and knows when a certificate has been used, it can automatically generate and send reports to the entity providing the gift certificates, such as employer 840. That is, for each manager of company 840, shopping cart 810 can issue a report relating to the account activities which can include redemption of gift certificates. In this manner, the manager can more efficiently manage the gift account.

An optional modified embodiment of the shopping cart 810 is as follows. When user 800 sends a Http: request for a merchant's site, the shopping cart 810 acts as a proxy for that request, as detailed above. Additionally, the shopping cart sends to user 800 a small screen scrapping program 855, which may implemented, for example, as a Java applet, Javascript code, etc. Thereafter, program 855 examines every Http: request from user 800 to see whether it includes at least one of a predetermined data fields, for example “buy”. If it doesn't the program 855 allows direct communication with the merchant, bypassing the shopping cart 810, as exemplified in the broken double-headed arrow. However, if one of a predetermined fields has been encountered, program 855 sends the Http: request to the shopping cart 810 for processing. This implementation drastically reduces the traffic load on shopping cart 810 server. That is, so long as user 800 merely browses a merchant's web site, all the communication is done bypassing the shopping cart 810 thereby avoiding bandwidth and processing load on sever 810. Consequently, shopping cart 810 needs to act as a proxy or perform processing only when an actual purchase transaction has been commenced. At that point, shopping cart 810 intercepts the request and processes it according to one of the embodiments detailed above.

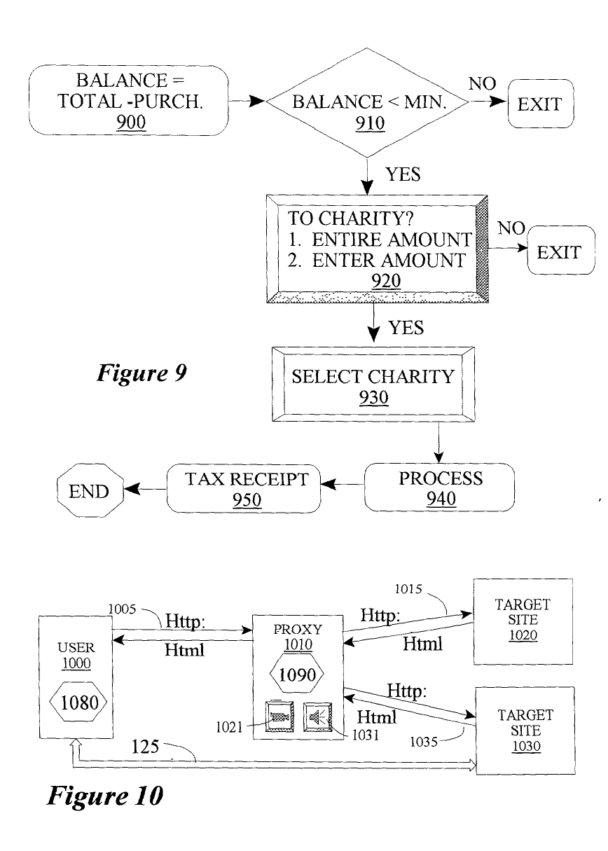

FIG. 9 is a flow chart of another feature of the invention which may be implemented in conjunction with the embodiments described above. In this example, described here with reference to FIG. 9, a gift certificate account has been established in the shopping cart for a user. When the user makes a purchase, the shopping cart calculates the new balance as the total available funds less the purchase amount (step 900). The shopping cart then checks to see whether the balance has reached a pre-programmed minimum amount (step 910). If not, the routine is terminated. However, if the minimum has been reached, the shopping cart sends a query to the user's computer asking whether the user wishes to donate the remaining funds or a portion thereof to charity (step 920). If the user indicates that he wishes to make a donation, the shopping cart displays a selection of charity organization for the user to make a selection (step 930). When the user select the charity organization, the shopping cart process the donation in a similar manner to a purchase transaction, e.g., deduct the donation amount from the user's account, generate payment transaction to the charity, etc. (step 940). Additionally, the shopping cart generates a tax deduction receipt and sends it to the user via, for example, email, fax, or regular mail (step 950).

Yet another feature which is very beneficial for use with a proxy arrangement is depicted in FIG. 10. This feature may be used in any proxy arrangement, including the embodiments of the proxy shopping carts detailed herein. In FIG. 10, user 1000 accesses target sites 1020 and 1030 via proxy 1010. For example, proxy site 1010 includes hyperlinks to target sites 1020 and 1030. When user 1000 clicks on any of the hyperlinks, proxy 1010 generates and Http: request for the index page of the target site. For example, when user 1000 clicks on icon for target site 1020, an Http: request, 1005, for that index page is generated at user 1000 and sent to proxy 1010. Proxy 1010 then generates an Http: request 1015 for the index page and sends it to the target site 1020. Target site 1020 generates an Html reply 1015 and sends it to the proxy 1010. Proxy 1010 then sends the Html reply to user 1000. This process is also followed for other Http: page requests other than the index page request.

As is well known in the art, web page html often includes images that need to be downloaded from the target site for display at the user computer. However, while web pages generally total a few kilobytes to a few tens of kilobytes, each image is generally several tens of kilobytes and the several images for one page can easily amount to a few hundreds of kilobyte. Thus, if a web page includes five images, downloading the images for the page may create high traffic at the proxy. However, according to the embodiment exemplified in FIG. 10, such traffic is eliminated. Specifically, a “mini-program” 1080, such as a Java applet or Javascript code is downloaded from proxy 1010 to user 1000. Program 108 examines and directs web traffic at user 1000. When program 1080 identifies an Http: request for a web page, it routes it to the proxy 1010. However, when the program 1080 identifies a request for image to be displayed within the page, it routes it directly to the target site, as exemplified by double-headed arrow 125. Consequently, heavy image traffic is avoided at proxy 1010.

An alternative embodiment to achieve reduction in traffic load on a proxy site is as follows. When a web page is received from a merchant as is forwarded to a user, an special HTML tag, e.g., a <BASE> tag, is inserted into the page. When the user's browser receives the web page, the tag directs the browser to fetch all objects relating to that page from a specified address, which is the address of the merchant, rather than the proxy. Thus, for all objects associated with the page, such as images and applets, the user's browser sends the request directly to the merchant rather than the proxy site. Consequently, according to this embodiment there is no need to download a mini-program onto the user's computer. Additionally, there is no need to perform an object-by-object inspection to determine where to obtain the object.

Another inventive feature exemplified in FIG. 10 is cookies manager 1090 in proxy 1010. As is well known in the art, many target sites upload cookies when a specific page is requested by a user. Each cookie has an origination identifier which is used each time the site is accessed again. The origination identifier is generated automatically as the web address of the originating web site. Thus, if target sites 1020 and 1030 upload cookies directly, i.e., not through proxy 1010, onto user 1000, the two cookies would be saved separately on user 1000 computer, each having its corresponding site address as the origination identifier.

However, a problem exists in the prior art when the cookies are uploaded via the proxy 1010. Specifically, as is known in the prior art, when an Http: request arrives at a target site from a proxy site, anything sent from the target site would be sent to the proxy site. Thus, for example, if an Http: request is sent from proxy 1010 to target site 1020, the html reply would be sent to proxy 1010, and proxy 1010 would send the received Html reply to user 1000, inserting proxy 1010 address as an originator of the Html reply. The same procedure applies to cookies. That is, if in reply to the http: request target site uploads a cookie, the cookie will have target site 1020 address as an origination identifier and will be sent to proxy 1010. The cookie will then be forwarded to user 1000 with proxy address 1010 as an origination identifier. Thus, all cookies passed via proxy 1010 are saved at user 1000 with proxy 1010 address as an origination identifier. Consequently, if at a later time user 1000 accesses any target site directly, i.e., not via the proxy 1010, the previously downloaded cookie will not be identified as originating from that target site and another cookie will be downloaded.

The embodiment depicted in FIG. 10 avoids this problem by including a cookie manager 1090. Specifically, when cookie manager 1090 identifies a cookie received from a target site and directed at a user, the cookie manager prevent proxy 1010 from inserting its address as an origination identifier. Thus, when proxy 1010 sends the cookie to user 1000, proxy 1010 address is not included in the cookie. In this manner, the address of the actual originating site is maintained for identification during future direct access.

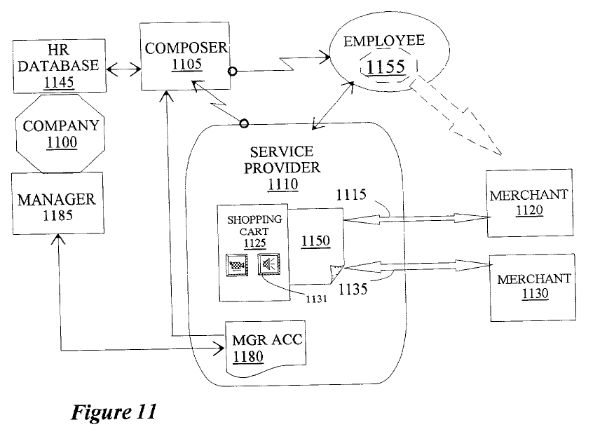

FIG. 11 exemplifies an embodiment incorporating various features of the present invention. In the embodiment of FIG. 11 service provider 1110 incorporates a shopping cart 1125 and a manager account 1180 features similar to those described above. Company 110 may maintain an HR database 1145, and employs manager 1185. Service provider 1110 may also maintain an event database 1160, shown in phantom. Composer 1105 is depicted as being independent to exemplify that it may reside on either company 1100 intranet, or on the service provider 1110 server.

In order to provide gifts on recurring events, such as birthday, anniversary, etc., either HR database 1145 or event database 1160 scans for events corresponding to the calendar. If an event is detected, the appropriate data is sent to the composer 1105 and the composer 1105 prepares and sends and email to employee 1190. For example, if HR database 1145 is used, the data sent to the composer may be the employee's first and last name, email address, and event code. On the other hand, if event database 1160 is used, the data may include only an employee number and an event code. The composer may then fetch the employee's name and email address from the HR database 1145.

The email to the employee 1190 may include a congratulation note, a hyperlink to service provider 1110 web site, and a gift certificate code. Additionally, an email may be sent to the employee's manager. The employee may then redeem the gift certificate by logging onto service provider 1110 web site by either clicking on the hyperlink or logging on independently using a web browser. Preferably, the employee will be requested to enter the gift certificate code as a password. The Employee's email may be used as a user name verification, either by extracting it from the email or by requesting the employee to enter it manually. When the gift certificate is verified, the employee is provided with a spending account having a specified credit thereupon. The employee 1190 may then use the credit to shop using shopping cart 1125.

In order to provide gifts on a non-recurring events, such as completion of a project, hiring bonus, etc., manager 1185 may be provided with a manager account 1180 having a specified credit amount therein. The manager may then use discretion in providing gifts to employees. To do that, manager 1185 logs onto manager account 1180 and uses composer 1105 to compose and send an email to employee 1190. As in the above, the email may include a gift certificate code to be used for logging onto shopping cart 1125.

Shopping cart 1125 uses screen scraper engine 1150 to screen merchants 1120 and 1130 web sites and construct fields database 1195. Additionally, links to the merchants web sites are provided on shopping cart 1125. When employee 1190 logs onto shopping cart 1125 the employee may use any of the links to shop at the merchants' 1120 and/or 1130 web sites. The screen scraper 1150, or optionally mini-program 1155 downloaded from service provider 1110, monitors all communication to and from employee 1190 in a manner similar to that described above. That is, service provider 1110 server is used as a proxy for employee 1190 for all communication to merchants 1120 and 1130. However, when a purchase request is detected by either screen scraper 1150 or mini-program 1155, the request is intercepted and is not transferred to the target merchant. Instead, the user account assigned to the employee 1190 is checked to see if it contains sufficient credit to cover the purchase price and, if so, the purchase price amount is deducted from the user account. The shopping cart prepares a purchase order using an assigned charge account, i.e., not an account of employee 1190, but rather than of company 1100 or service provider 1110. In this manner, from the merchant's perspective the product has been ordered and purchased with a valid payment account. On the other hand, from the employee's perspective, the purchase order was placed directly with the merchant (the proxy arrangement is transparent to the user), but the employee was not required to provide a charge account for the purchase. Additionally, since the shopping cart prepares the purchase order using the fields database 1195, it inserts the employee's address for shipping so that the product is shipped from the merchant directly to the employee—without the need to handling by company 1100 or service provider 1110.

It should be noted that since the various purchase order fields of the particular merchant can be fetched from fields database 1190, the shopping cart 1125 can request the appropriate information from the employee 1190. The fields may include, example, name, shipping address, shipping method, etch. Alternatively, the shopping cart 1125, acting as a proxy, transfer the information requests from the merchant, but use either the screen scraper 1150 or mini-program 1155 to strip the information from the responses sent by the employee 1155 and use the stripped information to construct the order using the fields from the fields database 1195. Another alternative is for shopping cart 1125, used as a proxy, to allow all information requests from the merchant to pass through to the employee and all responses from the employee to pass through to the merchant. However, when a request from a merchant for a charge account or payment is detected by the screen scraper 1150 or mini-program 1155, the request is intercepted and a replay is generated by the shopping cart 1125 using charge account of the company 1100 or service provider 1110. In this manner, all purchase and shipping information is sent from the employee 1190 to the merchant, except for payment information—which is sent from the shopping cart 1125.

While the invention has been described with reference to particular embodiments thereof, various embodiments and modification can be implemented by those skilled in the art without departing from the invention's scope and spirit, as defined in the appended claims.

1. A method for creating and managing an electronic gift certificate award and exchange program, comprising:
creating primary accounts database, each primary account defining a spending amount;
creating a single-point shopping cart site comprising links to commercial shopping web sites and fields database corresponding to said commercial shopping web sites;
providing an awardee with a gift certificate code;
enabling said awardee an access to said shopping cart using said gift certificate code and assigning a spending amount to said awardee;
accepting purchase requests for a product from one of said commercial shopping web sites from said awardee and placing a purchase order with said commercial shopping web sites; and,
deducting the purchase amount from said spending amount.

2. The method of claim 1, wherein said providing an awardee with a gift certificate code comprises composing and sending an email to said awardee, wherein said email includes said certificate code.

3. The method of claim 2, wherein said composing and sending step comprises enabling a primary user access to one of said primary accounts and using data entered by said primary user to generate said award email, and wherein said spending account is assigned from a primary account assigned to said primary user.

4. The method of claim 1, further comprising the steps:
monitoring an individuals database for events; and,
whenever an event is encountered, composing and sending said email to said awardee corresponding to the encountered event.

5. The method of claim 4, wherein said step of assigning a spending amount comprises selecting an amount corresponding to the encountered event.

6. The method of claim 1, wherein the step of creating a single-point shopping cart site comprises:
accessing the plurality of said commercial shopping web sites and, for each selected web site of the plurality of commercial shopping web sites:
identifying merchandise and purchase related fields in said selected web site;
creating entries for said merchandise and purchase related fields in said fields database on a proxy site;
creating a hyperlink on said proxy site linking to the selected web site.

7. The method of claim 1, wherein the step of accepting purchase requests further comprises:
monitoring web requests received from said awardee and:
when one of said web requests is for data from a selected site of said commercial shopping web sites, relaying the request to said site;
when one of said web requests is for a purchase of a product from said selected site, fetching purchase data from said fields database corresponding to said site, displaying at least part of said purchase data, composing a purchase order using at least part of said purchase data, and sending said purchase order to said selected site.

8. A gift certificate award and exchange system, comprising:
a composer operable to compose and send an award email to an awardee, including a certificate code;
a single-point shopping cart comprising links to commercial shopping web sites and fields database corresponding to said commercial shopping web sites;
a request monitor operable to monitor web requests received from said awardee and:
when one of said web requests is for data from a selected site of said commercial shopping web sites, relaying the request to said site;
when one of said web requests is for a purchase of a product from said selected site, comparing the product's price with the amount indicated by said certificate code and, if acceptable, composing a purchase order and sending said purchase order to said selected site.

9. The system of claim 8, wherein said single-point shopping cart further comprises:
a proxy site;
a screen scraper engine operable to access the plurality of said commercial shopping web sites and, for each selected web site of the plurality of commercial shopping web sites:
identify merchandise and purchase related fields in said selected web site;
create entries for said merchandise and purchase related fields in said fields database on a proxy site;
create a hyperlink on said proxy site linking to the selected web site.

10. The system of claim 8, wherein said single-point shopping cart further comprises:
at least one manager account defining credit amount therein; and,
wherein when said composer sends an award email to an awardee, including a certificate code, said certificate code is associated with an assigned gift amount from said credit amount.

11. The system of claim 8, further comprising an event database operable to scan for events and, when an event is detected, cause said composer to compose and send said award email.

12. The system of claim 10, wherein said single-point shopping cart further comprises:
at least one manager account defining credit amount therein; and,
wherein when said composer sends an award email to an awardee, including a certificate code, said certificate code is associated with an assigned gift amount from said credit amount.

13. The system of claim 10, wherein said request monitor is further operable to insert tags into web pages received in replay to said web requests, said tag directing web address to objects relating to said web pages.
